(19) United States
(12) Patent Application Publication
(10) Pub. No.: US 2009/0136307 A1
(43) Pub. Date: May 28, 2009

(54) GUIDING DEVICE FOR ENSURING STRAIGHT AND SMOOTH GUIDANCE OF A MOVEMENT

(76) Inventors: Kenneth Byro, Uddevalla (SE); Anders Ljungberg, Goteborg (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 12/299,791

(22) PCT Filed: May 8, 2007
(86) PCT No.: PCT/SE2007/000450

§ 371 Date: Nov. 6, 2008

Related U.S. Application Data
(60) Provisional application No. 60/802,025, filed on May 19, 2006.

(51) Int. Cl. B23B 47/28

(52) U.S. Cl. 408/115 R

(57) ABSTRACT

The guiding device has foldable legs that are connected to an upper connector and a lower connector. The legs are foldable along hinges. The hinges to the upper and lower connectors rotatably connect the ends of the legs. The guiding device may be moved from an expanded position to a collapsed position and moves along a straight line L. The guiding device may be used to hold drilling machines and other tools.

### TECHNICAL FIELD

The guiding device of the present invention provides a straight and smooth guidance of a movement.

### BACKGROUND AND SUMMARY OF THE INVENTION

Drilling machines and other similar tools must very often be moved in a very straight line as the drill-bit is forced through a work-piece to obtain the best results. Drilling holes precisely by relying on the eyesight is very difficult if not impossible. Additionally, the drill-bit often slides on the work-piece especially in the beginning of the drilling. Various attempts have been made to assist the user to move the drilling machine in a straight line. However, conventional guiding devices are cumbersome to use and sometimes cause the drilling machine to move along a non-linear line causing poor precision. Furthermore, devices based on a sliding mechanism might have a high frictional resistance along the line of movement causing erratic movement with stoppages or halts. Such devices are also sensitive to dirt and undesirable layers and the sliding mechanism is easily mechanically damaged. There is a need for a guiding device for drilling machines and other tools that provides a very straight and smooth guidance of the upward and downward movement relative to the work-piece.

The guiding device of the present invention provides a solution to the above-mentioned problems and drawbacks. More particularly, the guiding device may be used as a high precision drill guide that is based on hinges that resolves the disadvantages of conventional drill guides.

The guiding device of the present invention ensures movement in a straight line. The guiding device has a top connector and a bottom connector connected to the top connector by a first leg and a second leg. The first leg has an upper segment pivotally connected by a rotatable fastening device, such as a hinge, to a lower segment. The upper segment is pivotally connected by an upper rotatable fastening device, such as an upper hinge, to a side of the top connector. The lower segment is pivotally connected by a lower rotatable fastening device, such as a lower hinge, to a side of the bottom connector. Similarly, the second leg has an upper segment pivotally connected by a rotatable fastening device to a lower segment. The upper segment is pivotally connected by an upper rotatable fastening device to a side of the top connector. The lower segment is pivotally connected by a lower rotatable fastening device to a side of the bottom connector. The side of the top connector that is connected to the first leg and the side of the top connector that is connected to the second leg are angled relative to one another at an angle α wherein the angle α is 0°<α<180°. Similarly, the side of the bottom connector that is connected to the first leg and the side of the bottom connector that is connected to the second leg are angled relative to one another at the same angle α. The top connector is aligned above the bottom connector. The top connector is movable with a parallel motion relative the bottom connector along a straight line (L).

### BRIEF DESCRIPTION OF THE DRAWINGS

The invention will be described in more detail below with reference to the attached drawings in which:

FIG. 1 is a perspective view of the guiding device of the present invention;

FIGS. 2A-2D are perspective views of the guiding device of the present invention showing a movement from an expanded position to a collapsed position and back to the expanded position;

FIG. 3 is a detailed perspective view of a spring-loaded mechanism of the guiding device of the present invention;

FIGS. 4A-4D are perspective views of a drilling application of the guiding device of the present invention; and

FIGS. 5A-5C are perspective views of the guiding device of the present invention equipped with guiding rods.

### DETAILED DESCRIPTION

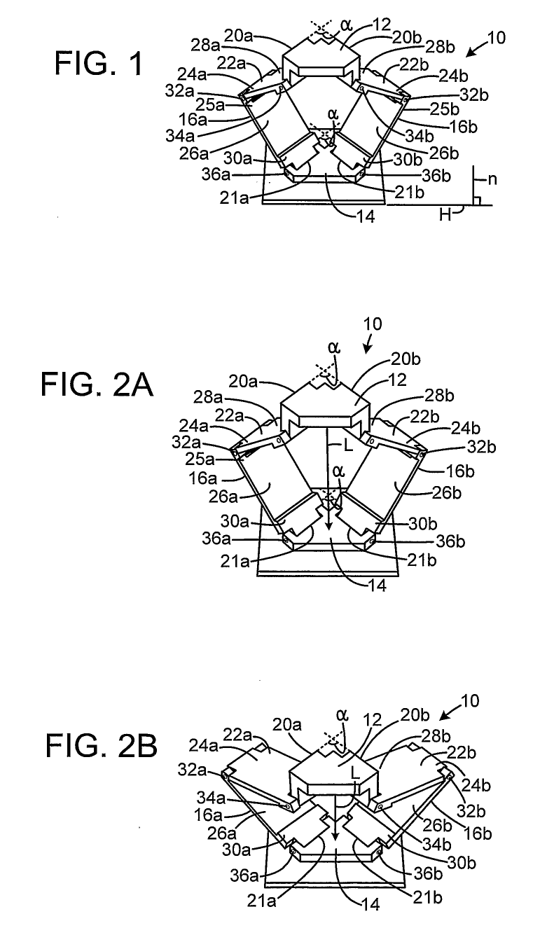

With reference to FIGS. 1-5, the guiding device of the present invention may be used to guide a movement along a straight line with high precision so that the movement does not diverge or only diverges very little from the path of a straight line. The frictional resistance is very low along the entire path of motion. This results in a straight movement in the direction of the path of movement being smooth and continuous, without tendencies of erratic movement, stoppages or halts.

The guiding device 10 of the present invention has a top connector 12 and a bottom connector 14 that are connected by a first foldable leg 16a and a second foldable leg 16b. The first leg 16a is virtually identical to the second leg 16b and only the details of the first leg 16a are described.

It is to be understood that the two foldable legs 16a and 16b do not have to be identical but this is preferable from a functional and a production point of view. For example, the length of the legs can be different and even the individual segments of the legs, 22a, 22b, 26a and 26b, can be of different length, as long as the top and bottom connectors compensate for this.

The top connector 12 may be triangle-shaped and has connector sides 20a, 20b that are angled at an angle α relative to one another.

Similarly, the bottom connector 14 may also be triangle-shaped and has connector sides 21a, 21b that are angled at the same angle α relative to one another. The angle α may be in the angle interval 0<α<180° or 180<α<360° depending on how the angle α is measured.

Preferably, the angle α is 90° to provide the best stability and precision but can vary within the interval as desired. The stability of the device gradually increases as the angle is increased from 0° to 90° and is then gradually reduced as the angle approaches 180°. When the angle α is 90° then the foldable legs 16a, 16b support each other for maximum stability. When the angle α is approaching 0° or 180° the foldable legs 16a, 16b only support each other to a small extent resulting in poor stability. When the angle α is 0, 180 or 360 degrees the foldable legs 16a, 16b no longer prevent the top connector 12 from moving sideways relative to the bottom connector 14.

It is to be understood that more than two foldable legs may be used. For example, when three foldable legs are used the angle between the legs should be angled relative to one another close to 120° to provide the best stability. Of course any suitable angle between the legs may be used.

Preferably, the bottom connector 14 is perfectly aligned below the top connector 12 so that the top connector 12 is precisely aligned on top of the bottom connector. The top connector 12 will be parallel to the bottom connector 14 when the top connector and bottom connector are moved relative to one another along a perfectly straight line (L) at all times.

The first leg 16a has an upper segment 22a that has a lower end 24a pivotally connected by a rotatable fastening device such as a hinge 32a to an upper end 25a of a lower segment 26a. An upper end 28a of the upper segment 22a is pivotally connected by an upper rotatable fastening device such as a hinge 34a to the connector side 20a of the top connector 12. A lower end 30a of the lower segment 26a is pivotally connected by a lower fastening device such as a hinge 36a to the connector side 21a of the bottom connector 14.

The components of the second leg 16b are pivotally connected in the equivalent way as the components of the first leg 16a. In this way, the top connector 12 may be aligned over the bottom connector 14 and the legs 16a, 16b both protrude outwardly and the top connector 12 may be moved with a parallel motion away from and towards the bottom connector 14 along a straight line L within the full length of the legs 16a, 16b. Preferably, the upper hinges (34a, 34b) should be located straight above the lower hinges (36a, 36b) as described by a normal (n) to a horizontal plane (H).

It is to be understood that the upper hinges (34a, 34b) do not have to be located straight above the lower hinges (36a, 36b) in order for the connectors to move relative to one another along the straight line (L) parallel to the normal (n). For example, the attachment area of the top connector 12 may be expanded relative to the attachment area of the bottom connector 14 to compensate for a difference in length between the leg 16a and the leg 16b.

The top connector 12 and the bottom connector 14 may be moved along the straight line (L) while being parallel relative to one another at all times as long as the three rotatable axles of the hinges 32a, 34a and 36a of leg 16a are parallel relative to one another and are perpendicular relative to the straight line (L) and the three rotatable axles of the hinges 32b, 34b and 36b of leg 16b are parallel relative to one another and are perpendicular relative to the straight line (L). In this way the bending movement of, for example, the leg 16a will follow a first plane that extends through the straight line (L) and the bending movement of the leg 16b will follow a second plane that extends through the straight line (L). The two planes intersect one another along the straight line (L) at the angle α.

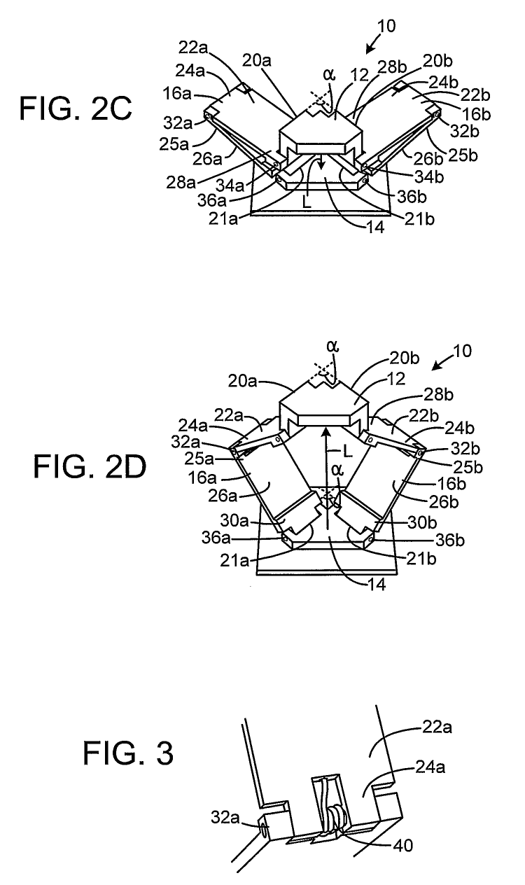

As best shown in FIGS. 2A-2C, the device 10 is movable between an expanded position (FIG. 2A) via an intermediate position (FIG. 2B) to a fully collapsed position (FIG. 2C) and then back to the extended position again (FIG. 2D). A very high precision is obtained during the motion along the straight line (L) by making all the hinges wide enough.

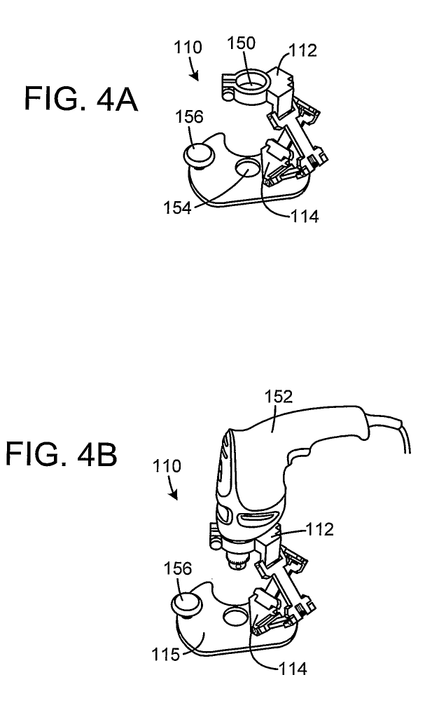

FIG. 3 is a detailed view of one of the hinges such as hinge 32a equipped with a biasing mechanism 40 such as a spring. The biasing mechanism may either bias the device into the expanded position as shown in FIG. 2A or into the collapsed position as shown in FIG. 2C. By fashioning the invention to erect itself when it is not loaded, the motion along the straight line L is accomplished by bringing on a force in the direction of the normal (n) and parallel to the line (L), which moves the connecting parts of the legs towards each other. When the force is removed the legs straighten and the connecting parts spring back to their initial position. The same principle that is exemplified in FIG. 3 could also be applied to obtain the present invention to become retracted in the un-loaded state and by applying a pulling force making it erect itself. The only difference in this case is the direction that the spring-load acts along. There are many other ways, than those described in FIG. 3, to make the device of the present invention become erected or retracted when no force is applied in the direction of the normal (n), for example by applying elastic bands or pads or tension- or compression-springs in suitable locations of the present invention.

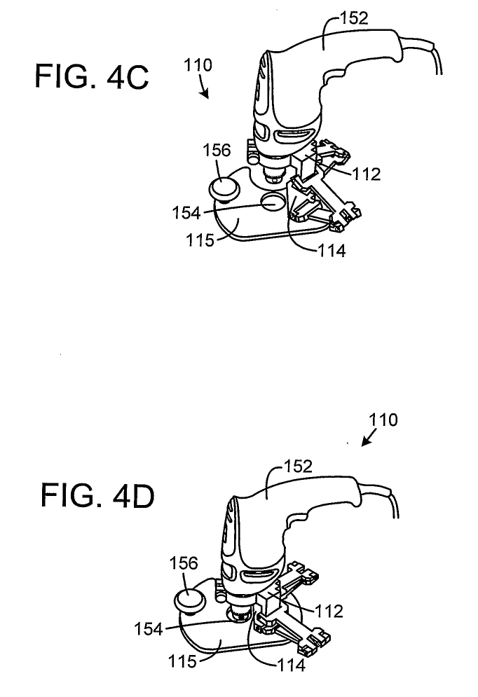

FIGS. 4A-4D are perspective views of an alternative embodiment 110 of the guiding device. More particularly, the device of the present invention can very favorably be used as a drill guide, which is an aid to drill holes in a work-piece at a certain angle, such as perpendicularly to a surface of a work-piece. This may be achieved by integrating an attachment for drilling machines in the top connector 112 as best shown in FIG. 4A and by adapting the bottom connector 114 connected to and/or mounted on a base plate 115 for such an application. The guiding device 110 is virtually identical to the guiding device 10 and only the main differences are described herein. The upper connector 112 has a clampable opening 150 for releasably holding a front end of a drilling machine 152. The connector 112 could be removable from the guiding device 110 if desired. Alternatively, the bottom connector 114 and the base plate 115 could be integrated. The base plate 115 has an opening 154 defined therein for the drill and/or the front end of the drilling machine 152. The device 110 may have a suitable handle 156.

With the drill guide outlined in FIGS. 4A-4D, an aid for precision drilling perpendicular to the work-piece is achieved. The drill guide in FIGS. 4A-4D may be equipped with an attachment that fits standard drills equipped with a collar. It is also possible to design a general-purpose attachment for an arbitrary drill or instead a specially designed attachment, only fitting a specific drill model or brand of drills. Preferably, the attachment is designed in a way that permits easy and swift mounting/dismounting of the drill in the drill guide. As an alternative to mounting the actual drill in the drill guide, it is possible to design an attachment that is journaled in the top connector 112 that grips the drill bit or the chuck. Another solution is to integrate a chuck that is journaled in the top connector 112 with a shaft that ascends from the chuck to which a drill can be attached.

To avoid sliding with the drill bit during the start of the drilling process, it is essential to accomplish a high friction between the base of the drill guide and the work-piece. This can be accomplished by attaching a rubber mat to the lower side of the base located below the bottom connector. To get a good handling grip when using the drill guide, a handle can be put on the upper side of the base.

A drill guide based on the present invention can easily be made adjustable to drill in different angles against the surface of the work-piece. A depth-stop is also easy to accomplish and can be fashioned in many different ways.

It is also possible to design different exchangeable bottom connectors/bases dedicated for special applications as a supplement to the general-purpose base, described in FIGS. 4A-4D which is intended for common drilling tasks. The bottom connector/base may be designed to be fastened to a vice, in which a work-piece can be fixated. The bottom connector/base may also be an integrated vice. The bottom connector/base may be designed for drilling in thin or elongated work-pieces like the edge of a board, strips, pipes and bars. The bottom connector/base may be designed to fit a specific shape of a work-piece. The bottom connector/base could also be adjustable to the shape of the work-piece.

As an alternative to using bottom connectors or bases, dedicated for special applications, the general-purpose base shown in FIGS. 4A-4D can be equipped with different accessories/attachments to making it perform well also in special applications.

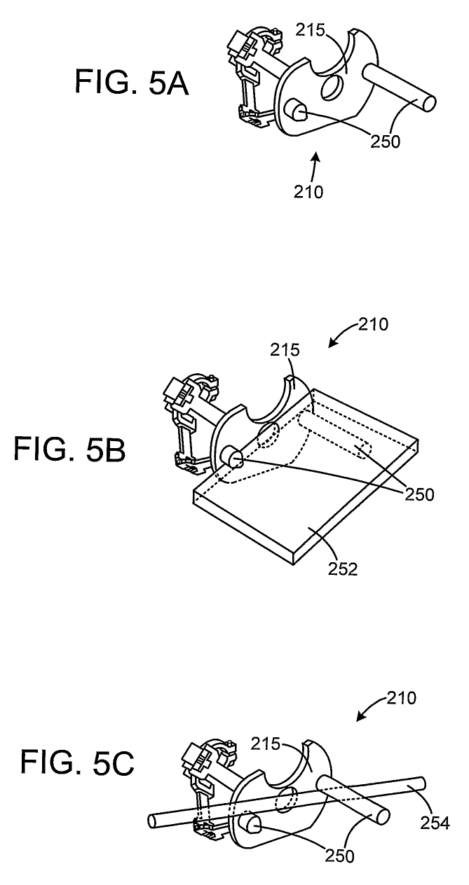

As an example of such an accessory/attachment, FIGS. 5A-5C show an attachment of an alternative embodiment 210 that facilitates drilling with excellent precision in thin or elongated work-pieces. The attachment consists of two guides in the form of cylindrical rods 250 that are mounted perpendicularly to the lower side of the base. The guiding rods may be symmetrically placed with the same distance from the path that the drill bit follows to obtain a centering mechanism.

The alternative embodiment 210 is virtually identical to the guiding device 10. Only the main differences are described herein. The base 215 may include cylindrical centering guides 250 mounted on the bottom side of the base. The bottom connector (not shown in FIG. 5) may be mounted on the base 215. This enables the precise drilling in work-pieces 252, 254 that are thin or elongated. For example, one of the guiding rods may be placed on top of the work-piece while the other guiding rod is placed below the work-piece to center the work-piece so that the user can then, for example, drill into the work-piece.

More particularly, if a hole is to be drilled in the center of the edge of a board, the guiding rod in the front of the base is placed against one side of the board and the drill guide is turned until the rear-guiding rod reaches the other side of the board. In this way, a very steady centering mechanism for drilling in the edge of a board is achieved. The centering mechanism works independently of the thickness of the board as long as it does not exceed the inner distance between the guiding rods. If the intended drill hole should be off-center of the board edge, one of the guiding rods is placed against one of the sides of the board and the drill guide is simply turned until the right point is targeted by the drill bit.

The accessory outlined in FIGS. 5A-5C can also be used to drill in elongated cylindrical work pieces such as pipes and bars 254. By using the same technique as described for drilling in the edge of a board, drilling in cylindrical work-pieces can be performed with excellent precision without sliding, which is very hard to achieve when drilling by eye.

The guiding rods for drilling in thin or elongated work-pieces can be integrated with the general purpose bottom connector/base in different ways by, for example, folding or pushing the guiding rods from the upper side to the lower side of the bottom connector/base in a simple operation. By keeping the guiding rods on the upper side of the bottom connector/base when not used, normal operation is not obstructed.

There are several other conceivable embodiments of the device of the present invention where the need for a smooth and uniform motion along a straight line is required.

The device of the present invention may be used as guidance of an electrical screwdriver to obtain high precision operation. The device reduces the risk of sliding with the screw bit in the screw head and thereby ruining the groove since the screwdriver cannot be misaligned to the screw. A special depth-stop could be devised to eliminate the screw from being screwed too deep. For example it can be spring-loaded so that the user feels when the depth-stop is nearing and can turn the machine off in time. A regular depth-stop used in conjunction with an electrical screwdriver could result in the destruction of bit and groove if the machine is not turned off when the depth-stop is reached and the screw continues to screw itself further resulting in bit and screw to separate.

The device could be used for guidance of threading tools, especially for tap threading. For guidance of a thread cutting machine, a device similar to the one shown in FIGS. 4A-4D could be used. For manual threading, the device of the present invention has the advantage of not being in the way of the tap wrench.

The device could be used as guidance of a springing or damping motion to attain that the motion follows along a straight line.

It could be used as guidance when nailing. A product based on the present invention that supports a nail below or above the nail head with the corresponding top connector. This makes it possible to achieve a straight drive of the nail and avoidance of bent nails. The device of the present invention could also be utilized to guide a nailing machine for precision operation.

The guidance of a cutting device like a saw or a knife, such as a device for chopping vegetables could be based on the present invention where the corresponding top connector has an attachment for a knife handle and the corresponding bottom connector can be attached to or put underneath a cutting board. By placing the tip of the knife on the cutting board, it is possible to attain a controlled chopping motion in a plane perpendicular to the cutting board with less risk of injury compared to chopping without aid.

Precision transportation in general, where an item is to be moved along a straight line is possible to accomplish with the present invention while providing a smooth and continuous motion.

The device of the present invention could also be utilized for applications where precision transportation along a straight line is not the main objective such as on the market there are drills that are equipped with dust extraction systems that have some type of suction nozzle that is put on top where the hole may be drilled. The nozzle may then be attached to the drill via some sort of guiding system to ensure that the drill bit aims in the center of the nozzle. The device of the present invention could be utilized as a suitable guiding system for such a dust extraction system. A dust extraction system could also be directly incorporated in a drill guide, based on the device of the present invention.

A product, based on the present invention, could be conceived that solves several embodiments such as one product could function as a drill guide, guidance for electrical screwdrivers and guidance for threading tools.

The fastening mechanism holding the drilling machine may be removable from the device. This enables easy engagement and disengagement of the drilling machine to the guiding device.

The device may also include a transportation or storage lock that may be a wedge shaped spring biased member that holds the fastener to the drilling machine. When the drilling machine and the fastener are removed the spring biased member may be attached to the rear-guiding rod so that the device can be transported or stored in the collapsed position.

While the present invention has been described in accordance with preferred compositions and embodiments, it is to be understood that certain substitutions and alterations may be made thereto without departing from the spirit and scope of the following claims.

1. A guiding device for ensuring a movement in a straight line, the guiding device comprising:
a top connector and a bottom connector connected to the top connector by at least a first leg and a second leg,
the first leg having a first upper segment pivotally connected by a first rotatable fastening device to a first lower segment,
the first upper segment being pivotally connected by first upper rotatable fastening device to a first side of the top connector,
the first lower segment being pivotally connected by a first lower rotatable fastening device to a first connector side of the bottom connector,
the second leg having a second upper segment pivotally connected by a second rotatable fastening device to a second lower segment,
the second upper segment being pivotally connected by a second upper rotatable fastening device to a second side of the top connector,
the second lower segment being pivotally connected by a second lower rotatable fastening device to a second connector side of the bottom connector,
the first side and the second side being angled relative to one another at an angle α wherein the angle α is 0°<α<180°,
the first connector side and the second connector side being angled relative to one another at the angle α, the top connector being movable with a parallel motion relative the bottom connector within a full length of the first and second legs along a straight line (L),
and the first rotatable fastening devices of the first leg being parallel relative to one another and perpendicular relative to the straight line (L) and the second rotatable fastening devices of the second leg being parallel relative to one another and perpendicular relative to the straight line (L) as the top connector and the bottom connector are moved relative to one another along the straight line (L).

2. The guiding device according to claim 1 wherein first and second upper ends of the first and second upper segments are movable towards and away from first and second lower ends of the first and second lower segments.

3. The guiding device according to claim 1 wherein the first and second upper segments and the first and second lower segments protrude away from the top connector and the bottom connector so that the first and second rotatable fastening devices are disposed outside the top connector and the bottom connector.

4. The guiding device according to claim 1 wherein the first and second rotatable fastening devices are hinges.

5. The guiding device according to claim 4 wherein the hinges include a biasing mechanism.

6. The guiding device according to claim 1 wherein a tool device is removably attachable to the top connector.

7. The guiding device according to claim 1 wherein a base connected to the bottom connector has an opening defined therein.

8. The guiding device according to claim 1 wherein the device has a locking mechanism for locking the device in a collapsed position.

9. The guiding device according to claim 1 wherein the top connector is removably attached to the device.

10. The guiding device according to claim 1 wherein the device has centering guides attached to a base connected to the bottom connector.

11. The guiding device according to claim 1 wherein the top connector is aligned above the bottom connector so that the first upper rotatable fastening device is straight above the first lower rotatable fastening device and the second upper rotatable fastening device is straight above the second lower rotatable fastening device.
